(19) United States
(12) Patent Application Publication
(10) Pub. No.: US 2016/0202737 A1
(43) Pub. Date: Jul. 14, 2016

(54) Real-time data acquisition and management equipment

(71) Applicant: Wen Pu, Beijing (CN)

(72) Inventor: Wen Pu, Beijing (CN)

(21) Appl. No.: 14/667,687

(22) Filed: Mar. 25, 2015

(30) Foreign Application Priority Data
Jan. 9, 2015 (CN) 201510008254.2

(51) Int. Cl. G06F 1/18

(52) U.S. Cl. CPC G06F 1/182; G06F 1/188

(57) ABSTRACT

a real-time data acquisition and management equipment includes: a body; an industrial Ethernet switch; a 24V power; an IPC; a solid-state disk; a memory; a UPS; a UPS battery; and a plurality of rails and terminals for installing above elements. If an industrial Ethernet environment is wireless network, a wireless network access point is added to the body. If a customer need to view acquired data or a pre-arranged interface on-site, and hopes to provide engineering works of programs and software on-site, a touch screen is mounted on an external surface of the body. In the equipment, pre-install programs and software are serialized according to requirements, for serializing functions and specifications of the whole equipment. If the software is mainly intelligent application, then the whole equipment is an industrial intelligent equipment.

### CROSS REFERENCE OF RELATED APPLICATION

The present invention claims priority under 35 U.S.C. 119(a-d) to CN 201510008254.2, filed Jan. 9, 2015.

### BACKGROUND OF THE PRESENT INVENTION

1. Field of Invention

The present invention relates to a real-time data acquisition and management equipment, which adapts to a variety of factories and workshops, and belongs to a technical field of information technology.

2. Description of Related Arts

According to conventional technical conditions, if workshop and factory want to deploy industrial software for manufacture management and analysis, an Ethernet environment must be built in the workshop for establishing communication with related equipment, and reading equipment operating data or manually entering data. The data are automatically saved in a database software system of a server through an Ethernet frame, and then are used by analysis software. Before the data is used by the analysis software, different project implementation units have different implementation programs, in different forms and with different qualities. For customers, project management is complex. Furthermore, it is difficult to standardize, duplicate and spread solutions. In addition, different implementation units will sometimes modify data acquisition and interface, so that the third party is not easy to directly read data. Therefore, for the customers, it is impossible to flexibly arrange development of manufacturing informatization.

In addition, with popularization of application of a new generation of Internet technology and Internet of things technology, more and more factories urgently need automatic, accurate and reliable acquisition of real-time data of production and peripheral facilities.

### SUMMARY OF THE PRESENT INVENTION

Because of the above technical defects and blanks, an object of the present invention is to provide a real-time data acquisition and management equipment, wherein the equipment combines a plurality of data sources into one data source, and communicates with a superior data application system server.

Accordingly, in order to accomplish the above object, the present invention provides:

a real-time data acquisition and management equipment, comprising: a body; an industrial Ethernet switch; a 24V power; an IPC (which is an industrial personal computer); a solid-state disk; a memory; a UPS (which is an uninterruptible power supply); a UPS battery; and a plurality of rails and terminals for installing above elements; wherein the industrial Ethernet switch is installed inside the body, and is connected to the IPC and on-site devices; the memory and the solid-state disk are installed inside the IPC; the UPS and the UPS battery are connected and both installed inside the body and outside the IPC.

According to different industrial standards and on-site environments, different kinds of the body are selected.

A net port quantity and a switch quantity of the industrial Ethernet switch are serialized.

A communication program and a data management software are pre-installed in the IPC.

If an industrial Ethernet environment is wireless network, a wireless network access point is added to the body.

A touch screen is mounted on an external surface of the body according to requirements.

If the data scale is not big (e.g. less than 500 tags), the software functionalities required are not complex (e.g. visualization), then an industrial panel pc can be a substitute of the above IPC and touch screen.

Advantages of the present invention are as follows. The present invention provides the real-time data acquisition and management equipment with a compact box-structure, which is applicable to a factory site with a variety of installation methods such as: mounted on a wall; hung on a ceiling; mounted on an upright post, a cantilever or a floor type cabinet; and mounted on a bearing upright post of other equipment. According to actual situations such as production lines, a section data quantity and a space layout, one line may be equipped with one equipment, a section may be equipped with one equipment, or a workshop may be equipped with one or more equipments. In short, a modular design concept is convenient for various layouts. The pre-installed software in the IPC is able to be serialized according to requirements, for serializing functions and specifications of the whole equipment. If the software is mainly intelligent application, then the whole equipment is an industrial intelligent equipment. If the software is only for basic data acquisition and management, then the whole equipment is a data acquisition equipment.

One skilled in the art will understand that the embodiment of the present invention as shown in the drawings and described above is exemplary only and not intended to be limiting.

### BRIEF DESCRIPTION OF THE DRAWINGS

Referring to drawings and a preferred embodiment, the present invention is further illustrated.

FIG. 1 is a front view of a body of a real-time data acquisition and management equipment according to the present invention.

FIG. 2 is an internal view of the body of the real-time data acquisition and management equipment according to the present invention.

### DETAILED DESCRIPTION OF THE PREFERRED EMBODIMENT

Referring to the drawings, the present invention according to a preferred embodiment is illustrated.

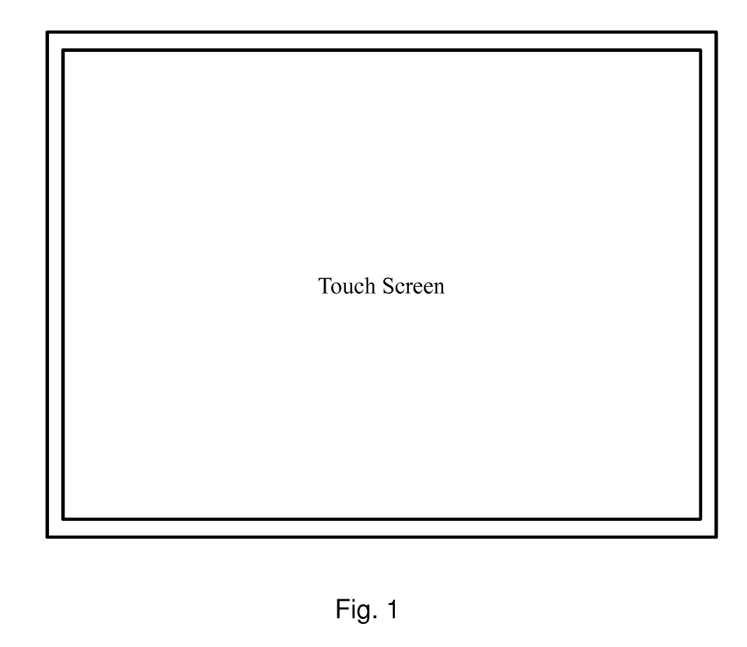

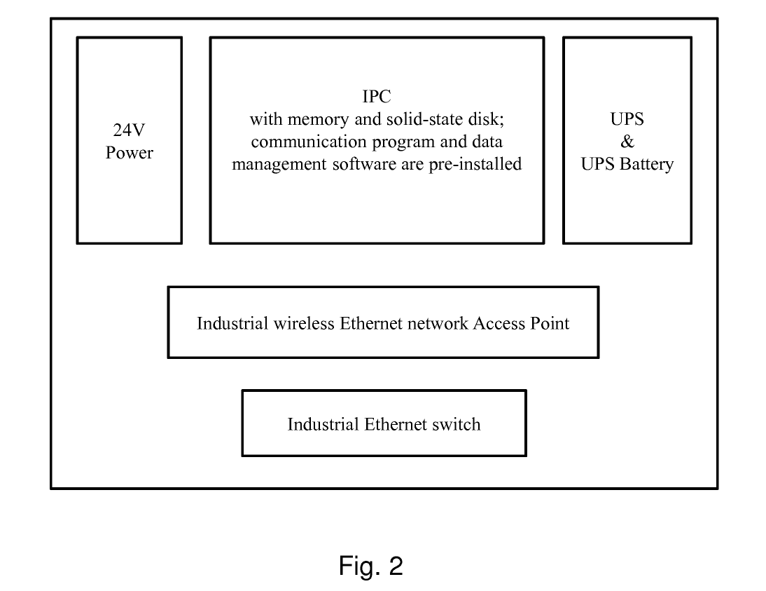

Referring to FIG. 1 and FIG. 2, a real-time data acquisition and management equipment comprises: a body; an industrial Ethernet switch; a 24V power; an IPC (which is an industrial personal computer); a solid-state disk; a memory; a UPS (which is an uninterruptible power supply); a UPS battery; and a plurality of rails and terminals for installing above elements; wherein the industrial Ethernet switch is installed inside the body, and is connected to the IPC and on-site devices; the memory and the solid-state disk are installed inside the IPC; the UPS and the UPS battery are connected and both installed inside the body and outside the IPC.

Preferably, according to different industrial standards and on-site environments, different kinds of the body are selected.

Preferably, a net port quantity and a switch quantity of the industrial Ethernet switch are serialized.

Preferably, a communication program and a data management software are pre-installed in the IPC.

Preferably, if an industrial Ethernet environment is wireless network, a wireless network access point is added to the body.

Preferably, a touch screen is mounted on an external surface of the body according to requirements.

Preferably, if the data scale is not big (e.g. less than 500 tags), the software functionalities required are not complex (e.g. visualization), then an industrial panel pc can be a substitute of the above IPC and touch screen.

Principles of the present invention are as follows. Devices (data sources) arranged in the Ethernet environment are connected to corresponding net ports of the industrial Ethernet switch through Ethernet cables (in a wireless Ethernet environment, the data sources are connected to the wireless network access point in the body). The industrial Ethernet switch combines the data sources and is connected to the IPC for pre-arrangement with the pre-installed data management software, so as to ensure continuous, stable and definite transmission to a superior data application system. The UPS avoids data loss due to sudden power cut off on site.

In summary, the present invention provides the real-time data acquisition and management equipment, wherein data acquisition, transmission process standardization and modularization are combined in one equipment, i.e. the real-time data acquisition and management equipment. The data sources such as factory equipment and instruments communicate with the equipment through Ethernet. The equipment combines the data sources into a comprehensive data source, and communicates with the superior data application system server (such as databases, analysis software and cloud apps). Customers are able to select different real-time data acquisition and management equipments and different quantities thereof according to factory characteristics and workshop layouts. With the modular and standardized equipment, by planning and implementing projects, the customer is able to obtain an effectively simplified system structure, and it is easy to standardize, popularized and duplicate. When it comes to factory relocation, expansion, or large-scale technical transformation, there is no need to worry about complex rebuilding of data acquisition system, because the factory only needs to restore the Ethernet environment with the modular equipment. In addition, for industrial application of Internet of things or industrial Internet of things application, the present invention, as information collection, reading and interactive systems of factory internal relative devices, stations, workshops and production lines, provides guarantee for further application.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A real-time data acquisition and management equipment, comprising:
a body; an industrial Ethernet switch; a 24V power; an IPC (which is an industrial personal computer); a solid-state disk; a memory; a UPS (which is an uninterruptible power supply); a UPS battery; and a plurality of rails and terminals for installing above elements;
wherein said industrial Ethernet switch is installed inside said body, and is connected to said IPC and on-site devices; said memory and said solid-state disk are installed inside said IPC; said UPS and said UPS battery are connected and both installed inside said body and outside said IPC.

2. The real-time data acquisition and management equipment, as recited in claim 1, wherein according to different industrial standards and on-site environments, different kinds of said body are selected.

3. The real-time data acquisition and management equipment, as recited in claim 1, wherein a net port quantity and a switch quantity of said industrial Ethernet switch are serialized.

4. The real-time data acquisition and management equipment, as recited in claim 1, wherein a communication program and a data management software are pre-installed in said IPC.

5. The real-time data acquisition and management equipment, as recited in claim 1, wherein an industrial Ethernet environment is wireless network, a wireless network access point is added to said body.

6. The real-time data acquisition and management equipment, as recited in claim 1, wherein a touch screen is mounted on an external surface of said body according to requirements.

7. The real-time data acquisition and management equipment, as recited in claim 1, wherein if a data scale is less than 500 tags, software functionalities required are visualization, then an industrial panel pc is a substitute of said IPC and a touch screen.
